(19) United States
(12) Patent Application Publication
(10) Pub. No.: US 2016/0060089 A1
(43) Pub. Date: Mar. 3, 2016

(54) FLUID DISPENSER

(71) Applicant: Armand R. NETTER, Grande Cache (CA)

(72) Inventors: Armand R. NETTER, GRAND CACHE (CA); John KIM, CHELSEA (CA); Kevin BAILEY, OTTAWA (CA)

(21) Appl. No.: 14/836,904

(22) Filed: Aug. 26, 2015

Related U.S. Application Data
(60) Provisional application No. 62/042,526, filed on Aug. 27, 2014.

(51) Int. Cl. B67D 1/08; B67D 1/10; B67D 1/00

(52) U.S. Cl. CPC B67D 1/0809; B67D 1/0004; B67D 1/0081; B67D 1/0857; B67D 1/10; B67D 2001/0812

(57) ABSTRACT

The present device discloses a fluid dispenser comprised of a piercing means to place and pierce a hole into a water bottle. Water from the water bottle travels from the piercing means through a pump which is connected to a water tank for cooling the water. A spout is connected to the water tank and activates the pump which funnels the water from the water bottle, into the water tank and through to the spout. The receiving means is located on the base of the fluid dispenser in order to position the water bottle adjacent to the water tank and keep the fluid dispenser compact and can prevent less spillage of water from the water bottle when pierced.

### CROSS REFERENCE TO RELATED APPLICATIONS

The present application claims priority to U.S. Provisional Application No. 62/042,526, filed on Aug. 27, 2014, the disclosure of which is incorporated herein by reference in its entirety.

### TECHNICAL FIELD

The invention relates to dispensers and, more specifically, to a cooled fluid dispensing system.

### BACKGROUND

Water coolers have been present for many decades, and are ever present in homes and offices to facilitate the consumption of cold water. Conventionally, a lever is activated in order to allow for the dispensing of either cold or ambient temperature water. Predominantly in offices, a large water bottle is opened, turned upside down, and forcibly inserted into an aperture that receives the water and allows it to be dispensed. Gravity acts as the mechanism to channel the water from the bottle to the dispenser. Other mechanisms are used as well, involving motors or other means to allow flow of water from a bottle to a spout.

Devices have been designed to facilitate the dispensing of water. U.S. Pat. No. 7,882,705 (Flax), U.S. Pat. No. 7,131,556 (Tseng), U.S. Pat. No. 4,993,229 (Baus) are examples of products that cool water for later dispensing.

Specifically, Baus discloses a water cooler with a thermoelectric cooler that cools water in a receptacle, as received from a bottle which was turned upside down and inserted within an aperture of the receptacle. Unfortunately, the bottle as disclosed and required for Baus' device needs to have its cap removed, and then turned upside down and inserted within. This leads to spillage of water from the bottle as it is turned upside down. Also, the size of the bottle is very cumbersome; it requires that someone with sufficient strength and dexterity is able to heave the bottle onto the cooler to properly dispense the water.

On the other hand, Tseng discloses a water cooler that is meant for pressurized drinks; however, it is also useful for regular beverages. Tseng discloses that in this instance, the bottle is to sit upright beside the water cooler. Meanwhile, the cooler is connected to the bottle by means of tubes. Water is dispensed from the bottle through another tube which runs all the way to the bottom of said bottle, feeding the water cooler which then cools the liquid before dispensing. Tseng also includes a means to allow for a device to be fastened directly onto the spout of the cooler which can minimize space. Unfortunately, Tseng's device does take up an unnecessary amount of space, and requires mechanical components that are otherwise unnecessary when dealing with stagnant or simply non-pressurized water.

Finally, Flax discloses a water cooler that comprises its own inner water tank connected to a bottle and a water filtration system. The bottle is turned upside down and fed into an aperture where the water is filtered before it lays in the water cool and gets chilled for consumption. This device is more compact; however, it still requires one to open the bottle cap and turn the bottle upside down for eventual dispensing. As was the case in Baus, this can be inconvenient and it provides spillage and discomfort for the user setting the bottle in the system.

As such, there is a need for a device that will overcome the aforementioned deficiencies. Indeed, there is a need in the market for a product that is smaller and more compact, will be able to pierce the bottle cap in order to eliminate the spilling of water to the surrounding area, and provide the necessary valves to allow for air to properly enter both the bottle and the water tank. Said type of device will be further described below.

### SUMMARY

In an aspect, the present invention provides a fluid dispenser comprising a housing for substantially encasing the fluid dispenser; a receiving means connected to the housing for receiving and positioning a water bottle within the fluid dispenser; a pump connected to the receiving means to transfer water out of the water bottle; a water tank and heat sink connected to the pump for storing and cooling the water; a spout connected to the water tank to dispense water from the fluid dispenser; wherein the receiving means is positioned on a base of the fluid dispenser.

### BRIEF DESCRIPTION OF THE DRAWINGS

The following figures serve to illustrate various embodiments of features of the invention. These figures are illustrative and are not intended to be limiting.

FIG. 1 is a perspective view illustrative of a fluid dispenser according to a first embodiment as described in the present invention;

FIG. 2a is a front perspective view illustrative of a fluid dispenser without its housing according to a first embodiment as described in the present invention;

FIG. 2b is a rear perspective view illustrative of a fluid dispenser without its housing according to a first embodiment as described in the present invention;

FIG. 3 is a front perspective view illustrative of a fluid dispenser without its housing and water tank housing according to a first embodiment as described in the present invention;

FIG. 4a is a perspective view of a transparent water tank with a partial cooling system and piercing member of a fluid dispenser according to a first embodiment as described in the present invention;

FIG. 4b is a perspective view of a transparent water tank with a partial cooling system and piercing member including a carriage of a fluid dispenser according to a first embodiment as described in the present invention;

FIG. 4c is a perspective view of a cooling system fastened to a transparent water tank of a fluid dispenser according to a first embodiment as described in the present invention;

FIG. 5a is a perspective view of a piercing member of a fluid dispenser without a carriage according to a first embodiment as described in the present invention;

FIG. 5b is a perspective view of a piercing member of a fluid dispenser with a carriage according to a first embodiment as described in the present invention;

FIG. 5c is a perspective view of a gasket attached to a carriage of a fluid dispenser according to a first embodiment as described in the prevent invention;

FIG. 5d is an upper perspective view of a piercing member within a gasket of a fluid dispenser according to a first embodiment as described in the prevent invention;

FIG. 6 is a perspective view of a piercing member of a fluid dispenser with a hooded vent according to a second embodiment as described in the present invention;

FIG. 7 is a cross-sectional view of a piercing member of a fluid dispenser with a hooded vent according to a second embodiment as described in the present invention;

FIG. 8 is a perspective view illustrative of a fluid dispenser according to a third embodiment as described in the present invention;

FIG. 9 is a perspective view illustrative of a fluid dispenser without its housing according to a third embodiment as described in the present invention;

FIG. 10 is a perspective view illustrative of a first check valve tube connected to a first check valve and a cooling system connected to a first water delivery tube according to a third embodiment as described in the present invention;

FIG. 11 is a perspective view illustrative of a piercing means fastened within a support means of a fluid dispenser according to a third embodiment as described in the present invention;

FIG. 12 is a perspective view illustrative of a fluid dispenser without its housing according to a fourth embodiment as described in the present invention;

FIG. 13 is a perspective view of a receiving means fastened on a water bottle, having a first water delivery tube and a first check valve tube secured within said receiving means according to a fourth embodiment as described in the present invention;

FIG. 14 is a perspective view of a fluid dispenser according to a fifth embodiment of the present invention;

FIG. 15 is a perspective view of a fluid dispenser without the housing according to a fifth embodiment of the present invention;

FIG. 16 is a perspective view of a fluid dispenser without the housing and half of the water tank housing according to a fifth embodiment of the present invention;

FIG. 17 is a perspective view of a fluid dispenser without the housing and half of the water housing and water tank according to a fifth embodiment of the present invention; and,

FIG. 18 is an exploded view of the water tank housing, water tank, float valve and heat sink according to a fifth embodiment of the present invention.

### DETAILED DESCRIPTION

The present device will now be described more fully hereinafter with reference to the accompanying drawings, in which preferred and other embodiments of the device are shown. No embodiment described below limits any claimed device and any claimed device may cover processes or apparatuses that are not described below. The claimed devices are not limited to apparatuses or processes having all the features of any one apparatus or process described below or to features common to multiple or all of the apparatuses described below. It is possible that an apparatus or process described below is not an embodiment of any claimed device. The applicants, inventors or owners reserve all rights that they may have in any device claimed in this document, for example the right to claim such an device in a continuing application and do not intend to abandon, disclaim or dedicate to the public any such device by its disclosure in this document.

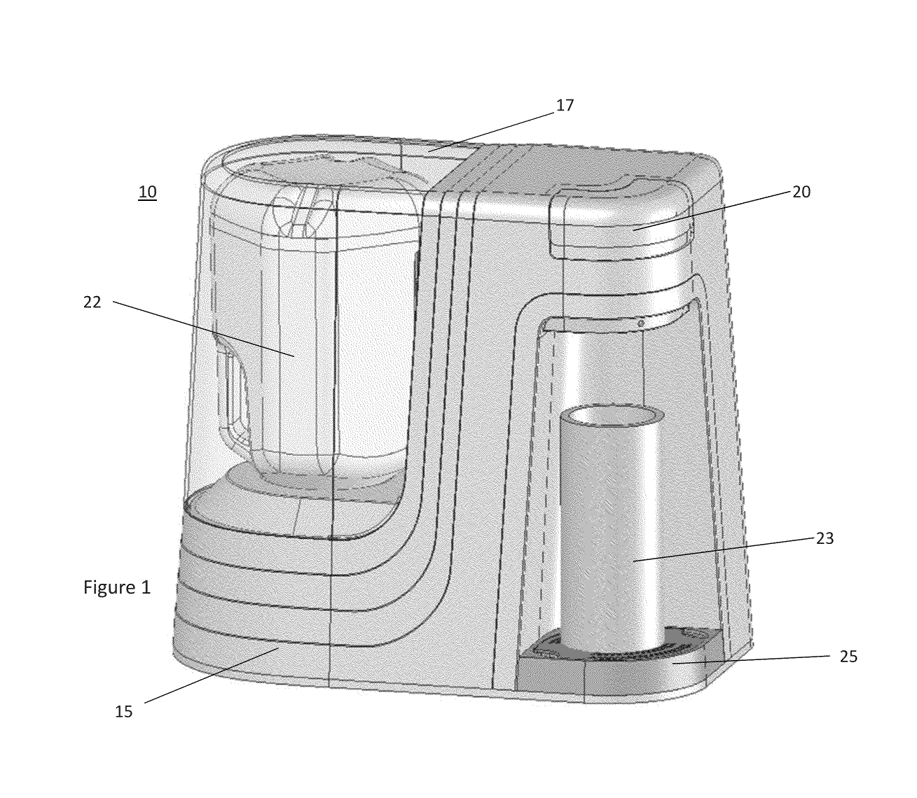

With reference to FIG. 1 and according to a first embodiment of the present invention, a fluid dispenser 10 is preferably comprised of a housing 15 for substantially encasing the fluid dispenser 10, including a removable lid 17 and a dispensing button 20 electrically connected to a pump (not shown). Pressing downwards on the dispensing button 20 activates a pump (not shown) which pumps water from a bottle 22 through the fluid dispenser 10 and ultimately out of a spout (not shown) and into a cup 23. A worker skilled in the relevant art would appreciate that the bottle 22 could be any size; however, given the compactness of the dispenser 10 the ideal is between 1-20 L. A spill tray 25 is present which is well known in the art and serves to catch any spilled water, either from early removal of the cup 23 or from overspill of the cup 23. To insert the bottle 22, the removable lid 17 is removed, and the bottle 22 is inserted upside down into a receiving means (not shown) comprised of a piercing means (not shown) which pierces the cap of the bottle 22 to allow the water or other liquid to flow freely into a water tank (not shown). The removable lid 17 is replaced back onto the housing 15, which conceals said bottle 22 and makes the fluid dispenser 10 more physically appealing and less cumbersome to handle. One of the primary features of the fluid dispenser 10 is its compact size allowing for the bottle 22 to be located adjacent, i.e. in the same horizontal plane, to the fluid dispenser 10. Said fluid dispenser 10 is further comprised of a cooling system (not shown) and spout (not shown) which are located within the housing 15, and unlike conventional water dispensers that allow for a cooling system and spout below the bottle, the present fluid dispenser 10 allows for them to be adjacent to the bottle 22.

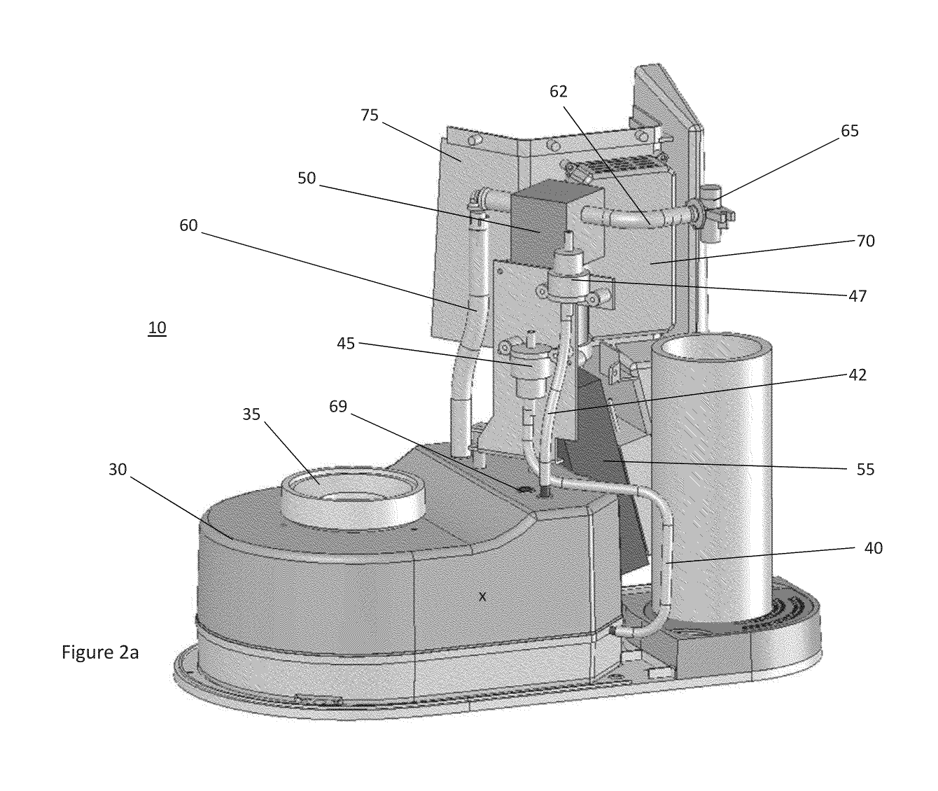

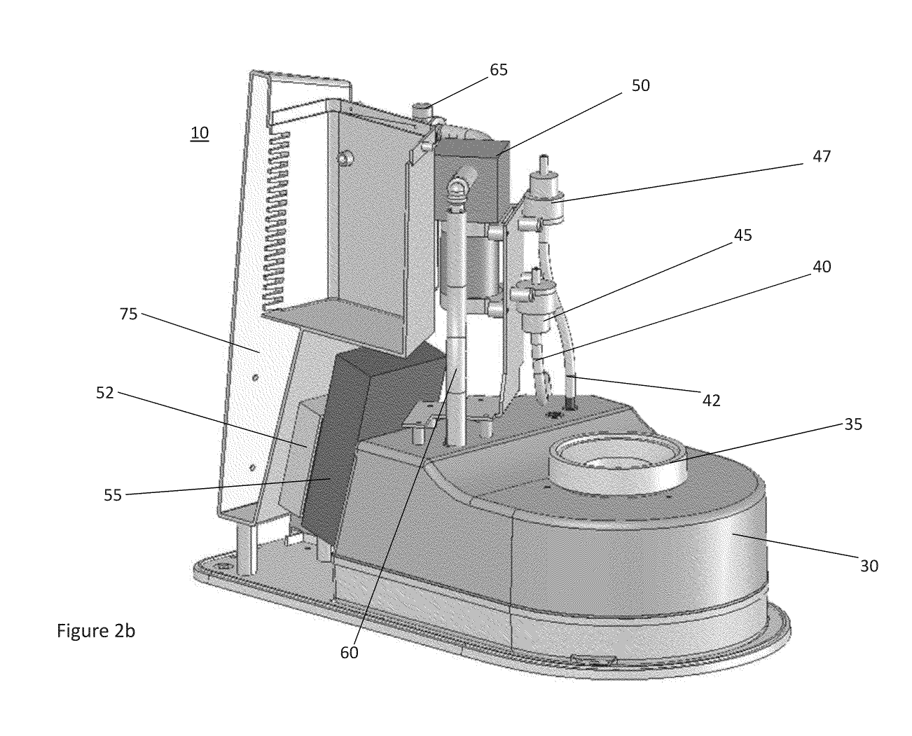

With reference to FIGS. 2a and 2b and according to one embodiment of the present invention, a fluid dispenser 10 is generally shown without the housing, removable lid and dispensing button. The fluid dispenser 10 is more generally comprised of a water tank housing 30 which houses a water tank (not shown), a receiving means 35 to receive the cap and neck of a bottle, first and second check valve tubes 40, 42, respectively connected to first and second check valves 45, 47, pump 50, fan 52, heat sink envelope 55, first and second water delivery tubes 60, 62 and spout 65. As water is expelled from the bottle, it enters and accumulates into a water tank (not shown) located and secured within the water tank housing 30. First check valve tube 40 and first check valve 45 are designed such that surrounding ambient air can flow into the bottle, while said bottle is emptied into the water tank (not shown). When the dispensing button (not shown) is activated, the spout 65, electrically connected to the pump 50, activates said pump 50 such that water is sucked from the water tank (not shown), through first water delivery tube 60 which is operatively engaged with the pump 50, then into said pump 50, through to the second water delivery tube 62 which is also operatively engaged with said pump 50, and ultimately out of the spout 65. As water draws out of the water tank (not shown), second check valve tube 42 and second check valve 47 allow air to enter said water tank (not shown). If water does make its way up the second check valve tube 42, a small float (not shown) located within the second check valve 47 will be lifted by the water up against an opening and block the escape of said water. When the water recedes, the float (not shown) will come down and allow air to be sucked back into the water tank (not shown). A temperature sensor (not shown) is located within the housing (not shown) over the water tank housing 30, and dips into a cavity 69 leading to the water tank (not shown) in order to regulate and maintain a correct water temperature, as desired. Said temperature sensor is well known in the art and will be further connected to the cooling system (not shown) to regulate the temperature. In order to keep the fluid dispenser 10 compact, it is designed such that the bottle is hidden within the housing (not shown). Therefore, as the bottle is located beside the spout 65 rather than above it, the water tank housing 30 must, by virtue of those design limitations, be located at a point that lower than said spout 65. Unlike prior art which has the bottle above or below the spout, in the fluid dispenser 10 the bottle is adjacent to the spout 65 and in the same horizontal plane as the fluid dispenser 10 and thus necessitates the use of a pump 50 to carry water from the water tank (not shown) through to the spout 65. The fluid dispenser 10 further comprises an electronic circuitry box 70 which is fastened to an air flow director 75. The electronic circuitry box 70 is electrically connected to a power source (not shown), pump 50 and a cooling system (not shown). The cooling system is comprised of the fan 52, heat sink envelope 55, heat sink (not shown) and heating element (not shown). As such, half of the cooling system which includes the heat sink (not shown) is encased within the water tank (not shown) to perpetually cool the stagnant water. The functioning of the cooling system will be further detailed below.

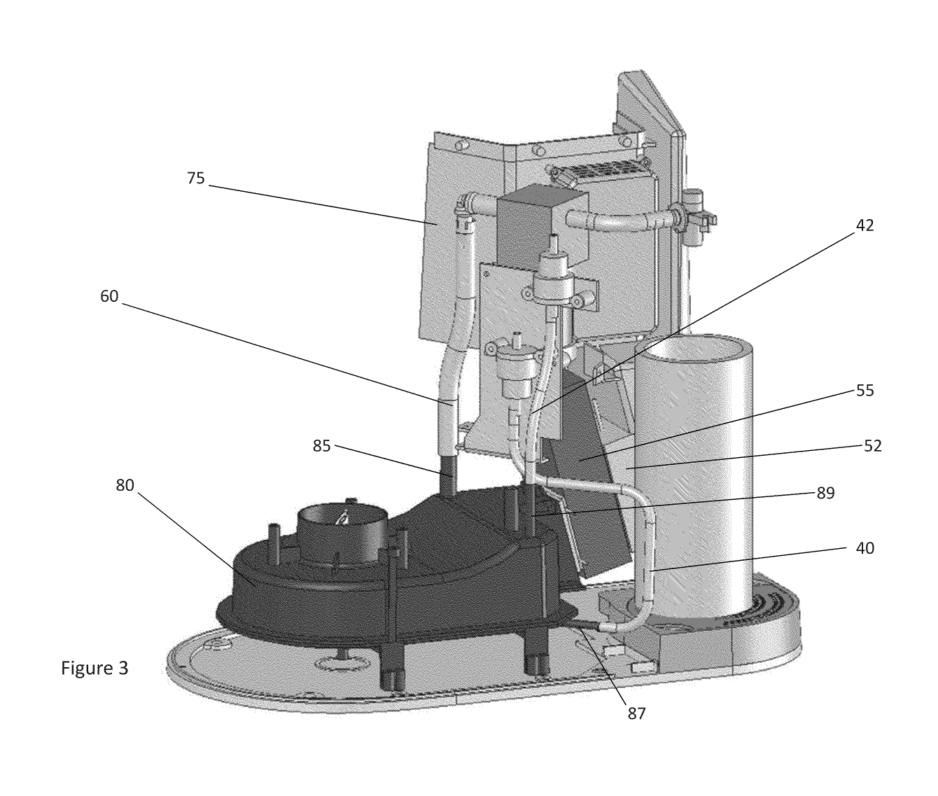

With reference to FIG. 3 and according to one embodiment of the present invention, a water tank 80 for storing water is shown secured to the housing (not shown) and connected to the first water delivery tube 60, as well as first and second check valve tubes 40, 42 by means of first, second and third hoses 85, 87, 89, respectively. In order for water to exit the bottle or the water tank 80, air needs to be allowed to enter said medium and create the proper fluid flow. Therefore, while first hose 85 allows the exit of water from the bottle and water tank 80; second and third hoses 87, 89 allow for the entry of air into the bottle or water tank 80 respectively. Meanwhile, the fan 52 and heat sink envelope 55 are engaged with the water tank 80 such that the cooling system (not shown) such as Peltier cooler, can have its cooling portion such as a heat sink (not shown) within the water tank 80 to cool the stagnant water within it, and heating portion such as a heating element (not shown), such that the fan 52 can dissipate the heat, by moving the air from said heating portion into the air flow director 75.

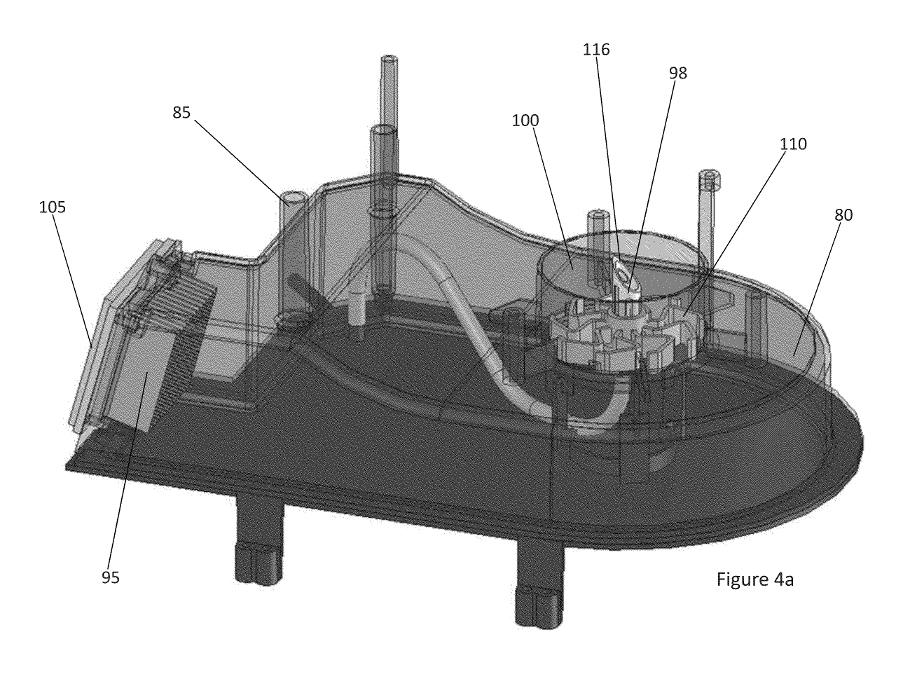

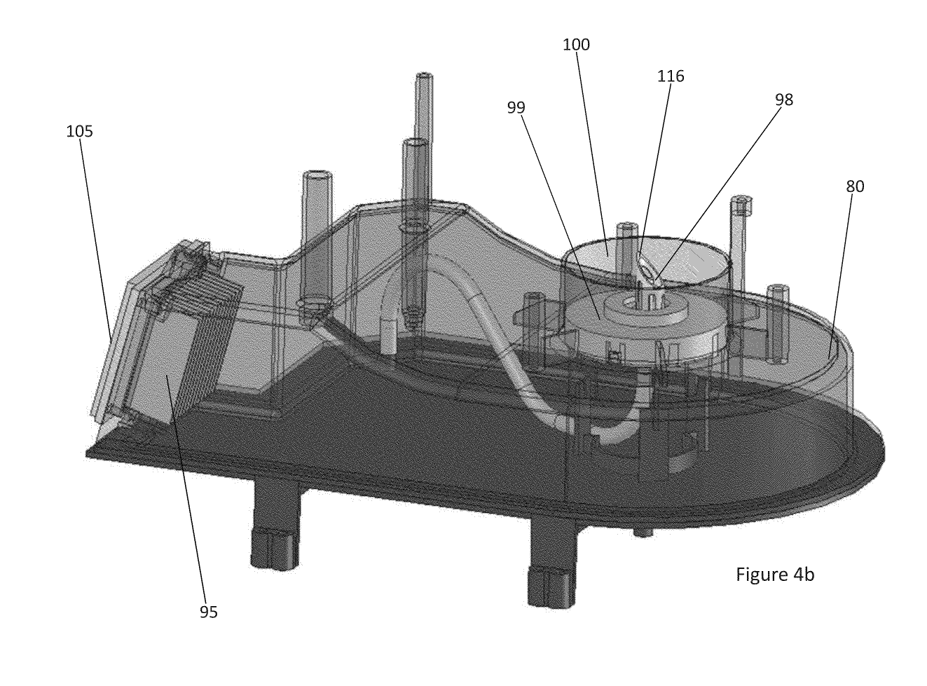

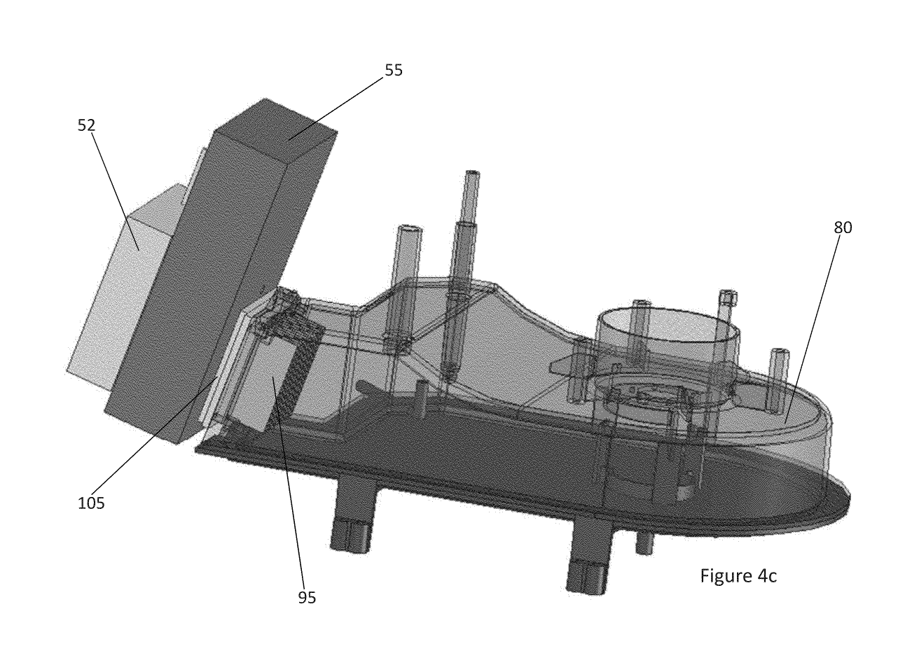

With reference to FIGS. 4a and 4b and according to one embodiment of the present invention, the water tank 80 is shown transparently, such that a heat sink 95 is visible, connected to the inside of said water tank 80 to come into contact with the stagnant water within. While FIG. 4a shown the water tank 80 without a carriage 99, FIG. 4b shows the water tank 80 with said carriage 99. A heating element 105 is shown opposite the heat sink 95, which will become hot as is well-known in the art of thermoelectric coolers. A fan (not shown) is secured to the heat sink envelope (not shown) and ultimately to the heating element 105 in order to distribute the warm air surrounding said heating element 105 out of the fluid dispenser 10 by means of air flow director (not shown) and small openings (not shown) on the housing (not shown). Said fan (not shown), heat sink envelope (not shown) heat sink 95 and heating element 105 form the cooling system of the present invention. A piercing member 98 is shown, protruding from an opening 100 of the water tank 80 and fastened to said water tank 80 by means of carriage 99. Said piercing member 98 has a cutting tip 116 which pierces the bottle, and allows water to flow into the water tank 80. Said piercing member 98 and cutting tip 116 will be further described below. The first hose 85 is also shown which is linked within the water tank 80 and allows water to be sucked into it and eventually to the spout (not shown). The first hose 85 does not protrude all the way down into the water tank 80 such that the water level within the water tank 80 is always high and thus the water tank 80 is always full. Should the water level go below the length of the first hose 85, the water bottle (not shown) must be replaced.

With specific reference to FIG. 4b and according to one embodiment of the present invention, a carriage 99 is fastened to the water tank 80 by means of small notches (not shown). The carriage 99 is secured over stabilizing means 110, said stabilizing means 110 being in a contracted position therein.

With reference to FIG. 4c and according to one embodiment of the present invention, the cooling system is shown fastened to the water tank 80. Said cooling system is comprised of the fan 52, heat sink envelope 55, heating element 105 and heat sink 95, and its functioning was explained above.

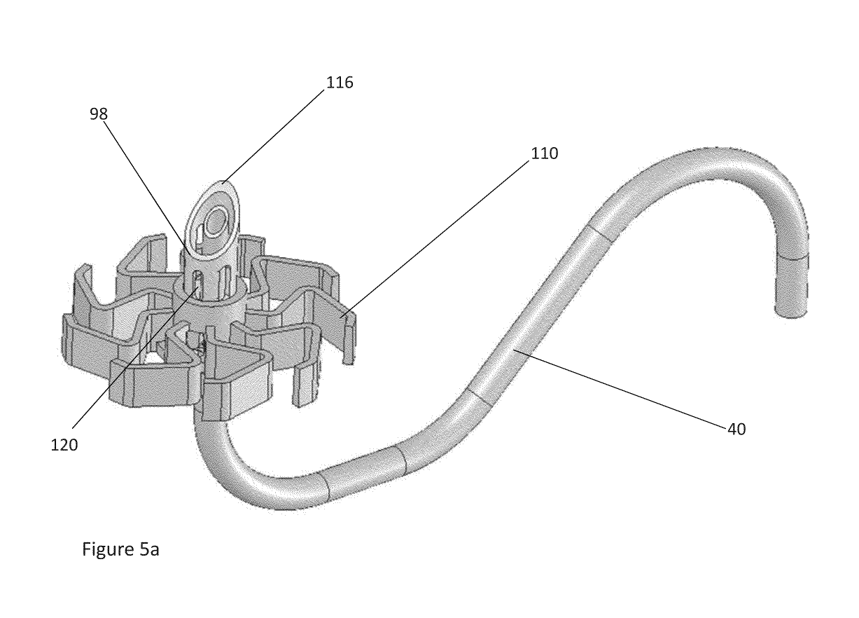

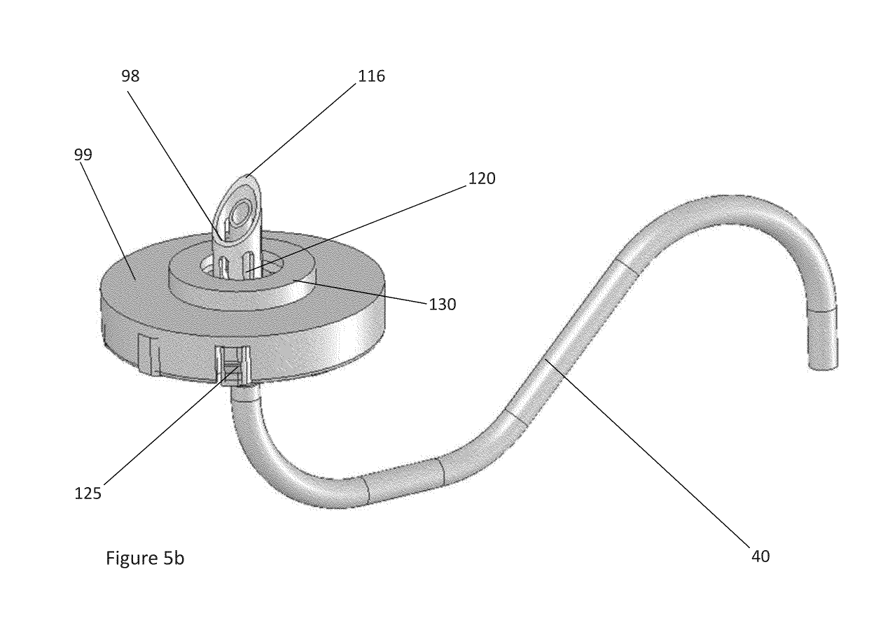

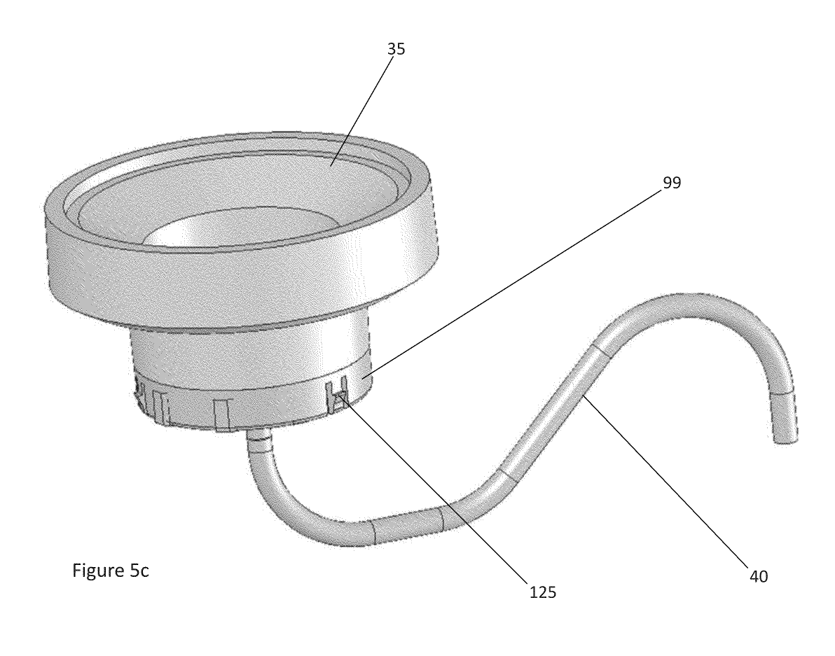

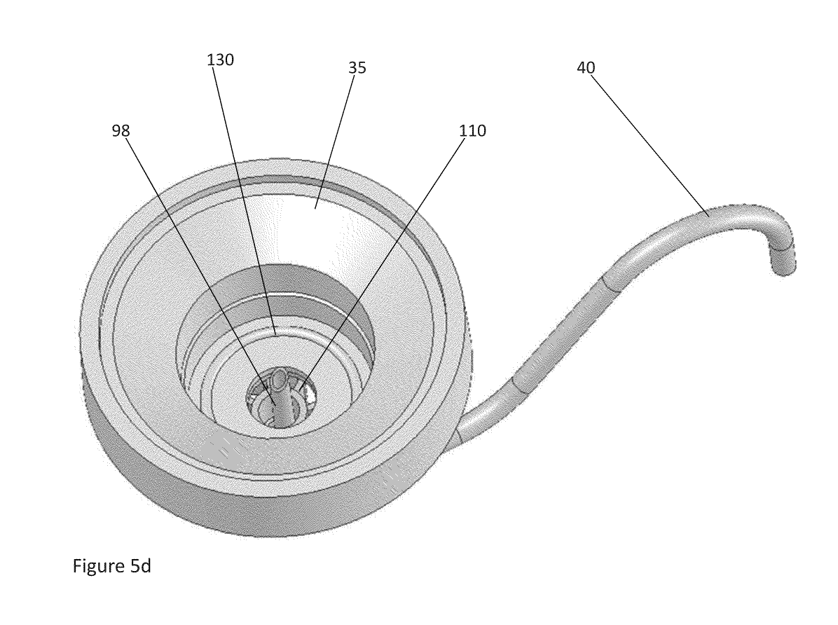

With reference to FIG. 5a and according to one embodiment of the present invention, the piercing member 98 is shown connected to a stabilizing means 110. Said stabilizing means 110 allows for the re-positioning of the bottle should said bottle be inserted off-centre. In order words, when the bottle is introduced into the receiving means (not shown) and ultimately into an aperture (not shown) of the water tank (not shown) by its cap, the cutting tip 116 of the piercing member 98 will perforate said cap. Water will flow generally both into and around first check valve tube 40 and will then flow out of slits 120 positioned on the piercing member 98. From the slits 120, the water will then flow into the water tank (not shown). While some water flows into the first check valve tube 40, the upwards positioning of the first check valve tube 40 will generally prevent said water from flowing through the first check valve tube 40 all the way to first check valve (not shown). However, if water does eventually flow to first check valve (not shown), it is prevented from escaping by the inherent function of said first check valve (not shown), which is to say that the first check valve (not shown) will close when water pressure is created in the first check valve tube 40.

With reference to FIGS. 5b, 5c and 5d and according to one embodiment of the present invention, the stabilizing means 110 is secured within the carriage 99. The carriage 99 is further comprised of notches 125 in order to be secured within the water tank (not shown). When the bottle is placed over the piercing member 98, the cap of the bottle is flush against a seal ring 130 located within the receiving means 35. In turn, the receiving means 35 is flush against the carriage 99 as is specifically shown in FIG. 5b. The shape of the receiving means 35 allows for the bottle to be placed off-centre relative to carriage 99 and stabilizing means 110, and the seal ring 130 prevents water to flow into the inner portion of the receiving means 35, thereby forcing said water only into the piercing member 98 and thus ultimately into the water tank (not shown).

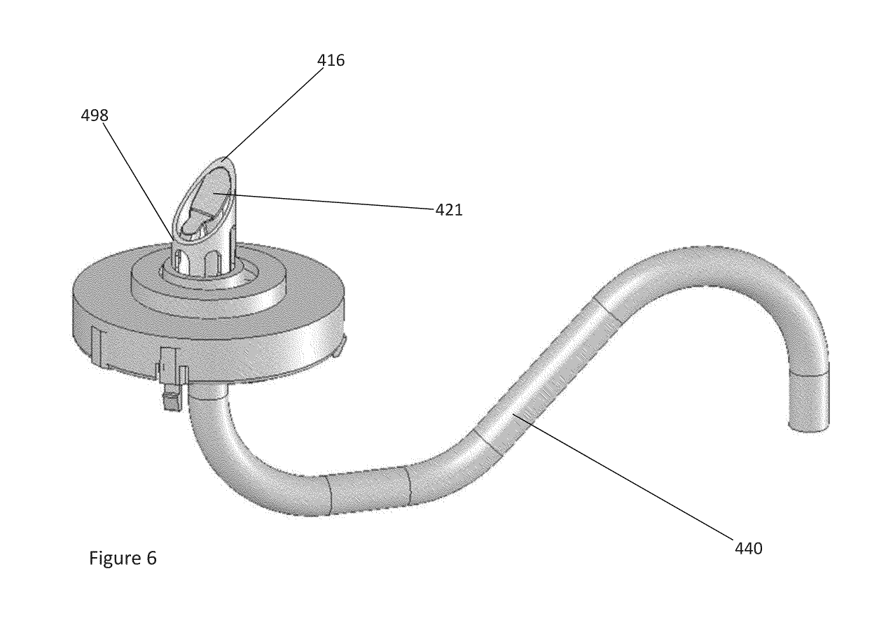

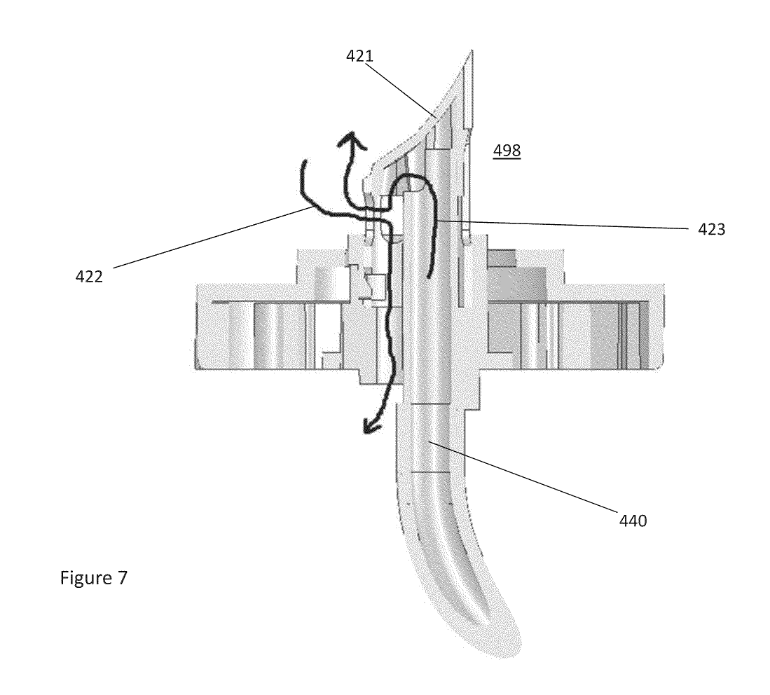

With reference to FIGS. 6 and 7 and according to a second embodiment of the present invention, the piercing means 98 is shown further comprised of a hooded vent 421. The first check valve tube 440 is terminated by said hooded vent 421 in order to allow air to enter the water bottle, without allowing any water to enter the first check valve tube 440. This is in direct contrast with the first embodiment, where water will inevitably flow into the first check valve tube by reason of the inherent positioning of the first check valve tube opening. Therefore, the addition of the hooded vent 421 obviates the need for the first check valve. Arrow 422 shows the movement of the water that will originate from the water bottle being positioned upset down over the gasket (not shown). Said arrow 422 shows one possible path that the water could take in order to get into the water tank (not shown). In contrast, arrow 423 shows the path that air will travel, along first check valve tube 440 and under the hooded vent 421, and ultimately into the water bottle. A worker skilled in the art would appreciate that water exiting the water bottle and coming into the water tank (not shown) will be prevented from directly entering the first check valve tube 440 as the hooded vent 421 covers the upper opening of said first check valve tube 440.

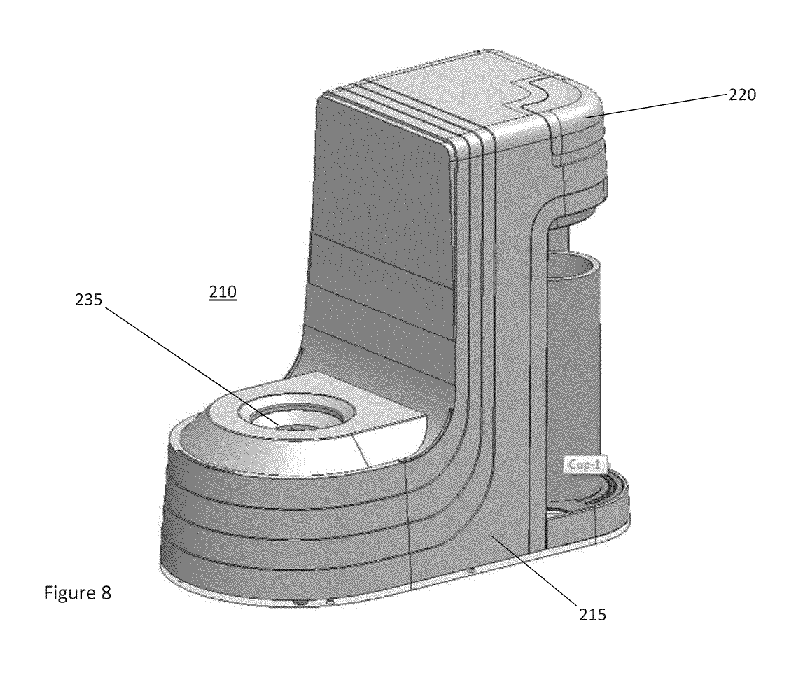

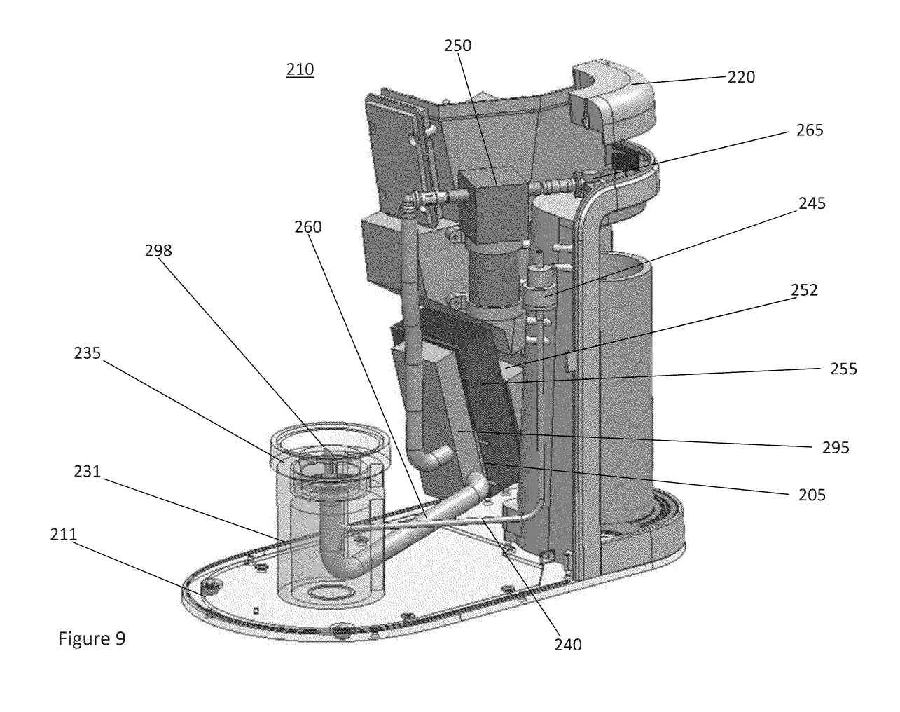

With reference to FIGS. 8 and 9 and according to a third embodiment of the present invention, the fluid dispenser 210 is shown generally comprised of a housing 215, and a receiving means 235 engaged with said housing 215 for receiving and positioning a water bottle within the fluid dispenser 210. A first water delivery tube 260 is engaged with the receiving means 235, and serves to direct a water flow from the water bottle, through a cooling member 295 of a cooling system, a pump 250 and out of a spout 265. A piercing member 298 is also present which serves to pierce the neck of the water bottle in order to allow water to flow through and into the first water delivery tube 260. A first check valve tube 240 is shown located within the piercing member 298 and allows air to enter the water bottle from the first check valve 245, as is necessary under operating conditions. A support means 231 is also shown fastened to both the base 211 and the receiving means 235 of the fluid dispenser 210, in order to provide the necessary support for said receiving means 235 when the water bottle is placed upon it. During operation, water will flow from the water bottle through the first water delivery tube 260. Said first water delivery tube 260 is operatively engaged with the cooling member 295 of the cooling system, which serves to cool water immediately as it is flowing from the water bottle to the spout 265. As was the case in the first embodiment, the cooling system is comprised of the cooling member 295, a heating element 205, a heat sink envelope 255 and a fan 252. In this third embodiment, the cooling member 295 is designed to allow the first water delivery tube 260 to coil within it, in order to sufficiently cool the water from the water bottle approximately 10 degrees Celsius. A pump 250 is operatively engaged with the first water delivery tube to provide a suction means for water to be directed from the water bottle through to the spout 265, said spout 265 being also connected to the water delivery tube 260 to provide a channel for water to be expelled from the fluid dispenser 210. As in the first embodiment, once the dispensing button 220 is pushed, it activates the spout 265 which is electrically engaged with the pump 250 to pump water from the water bottle and through to the cooling member 295. The use of the first check valve 245 and first check valve tube 240 in combination with the receiving means 235 allows the water bottle to be positioned in the same horizontal plane as the fluid dispenser 210, thereby providing a compact size to the said fluid dispenser 210.

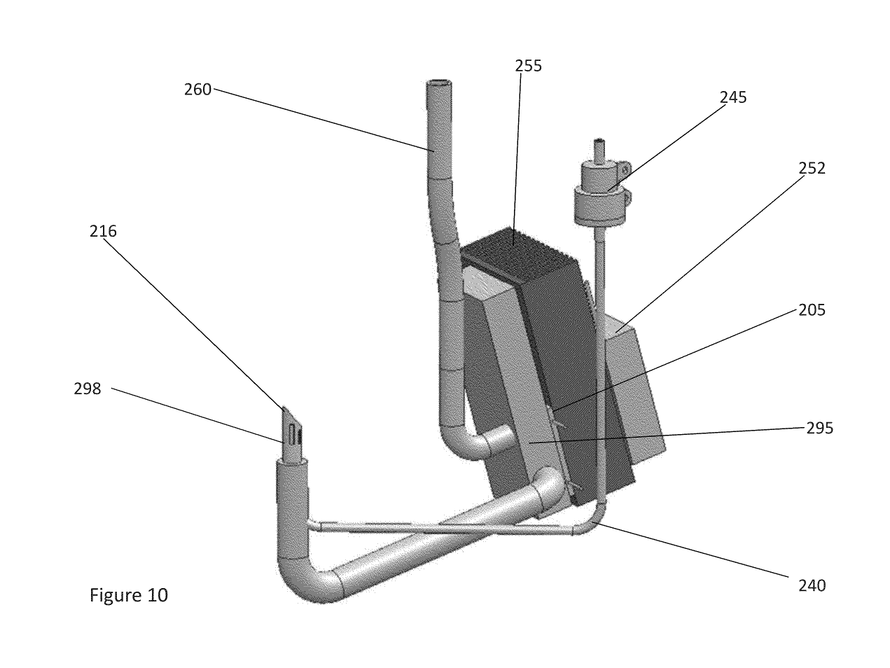

With reference to FIG. 10 and according to a third embodiment of the present invention, the cooling system comprised of the cooling means 295, heating element 205, heat sink envelope 255 and fan 252, is shown having its cooling means 295 connected to the first water delivery tube 260. In turn, the first water delivery tube 260 is terminated in a piercing member 298, further comprised of a cutting tip 216. Meanwhile, a first check valve tube 240 is shown, having a first end terminating in the first check valve 245, while the second end terminates within the piercing member 298 of the first water delivery tube 260. It is to be appreciated that the first check valve tube 240 must eventually be separated from the first water delivery tube 260 in order to function properly. Indeed, the first check valve tube 240 requires to be designed in order to be separated from the first water delivery tube 260 in order to reach the first check valve 245.

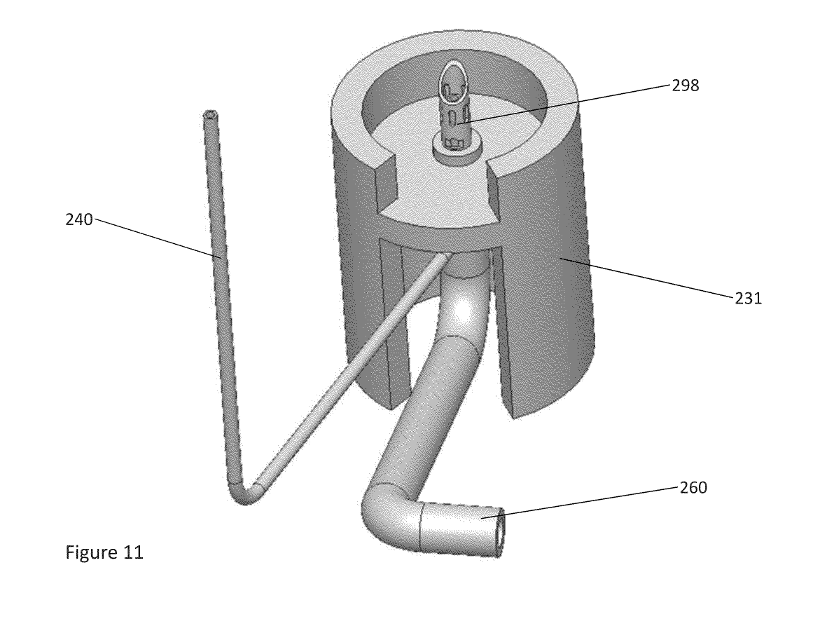

With reference to FIG. 11 and according to a third embodiment of the present invention, the support means 231 is shown, having the first check valve tube 240 and first water delivery tube 260 fastened to said support means 231. The piercing member 298 protrudes from the support means 231 in order to pierce the bottle, and is supported by said support means 231 to provide the necessary force to pierce the neck of the bottle in operation.

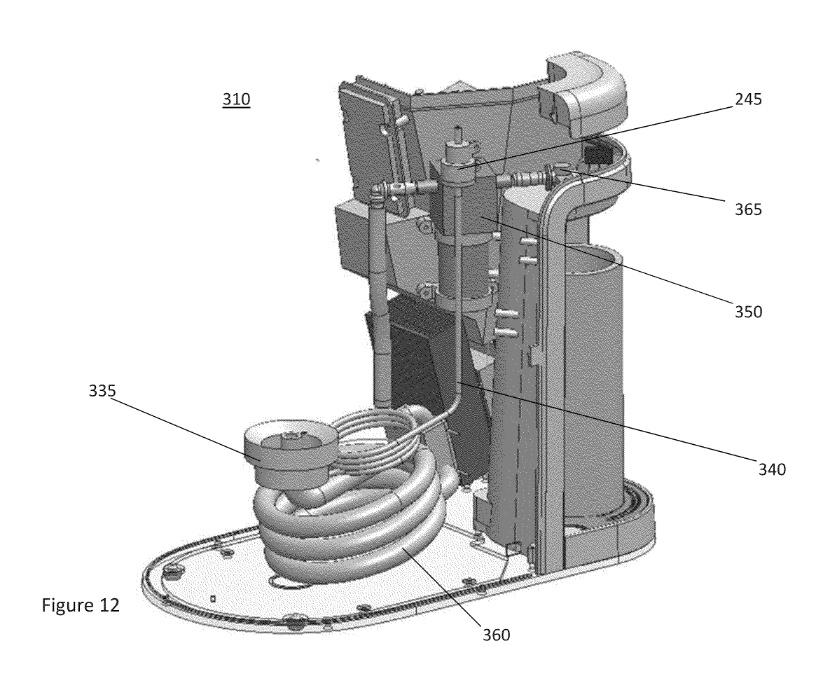

With reference to FIG. 12 and according to a fourth embodiment of the present invention, a fluid dispenser 310 is shown comprised of a receiving means 335, releasably fastened to the housing (not shown) and connected to the first water delivery tube 360 and first check valve tube 340. Together, the receiving means 335, first water delivery tube 360 and first check valve tube 340 can be disconnected from the housing (not shown) in order to connect to a water bottle. Indeed, the first water delivery tube 360 and first check valve tube 340 are lengthy and coiled within the housing (not shown) such that they can be extended towards a water bottle. Therefore, the water bottle can be in an initial upright position, before the receiving means 335 along with the first water delivery tube 360 and first check valve tube 340 are removed from the fluid dispenser 310. Said receiving means 335 is then placed onto the neck of the water bottle and forms a sealed connection therewith to prevent the egress of water, eliminating the need for a piercing means. The water bottle is then positioned upside down within the fluid dispenser 310, in the same horizontal plane as said fluid dispenser 310. In order to properly position the water bottle on the fluid dispenser 310, the first water delivery tube 360 and first check valve tube 340 must be coiled back to be stored within the housing (not shown). A worker skilled in the relevant art would appreciate that the receiving means 335 could be any type of rubber material that can deform onto the neck of the water bottle and sealingly squeeze in place. Alternatively, said receiving means 335 could be a snap-on type or of threaded type for engagement onto the neck of the water bottle, without departing from the scope of the invention. The remainder of the functioning of the fluid dispenser 310 is much the same as is the case in the third embodiment. That is to say, a pump 350 is operatively engaged with the first water delivery tube 360 to provide a suction means for water to be directed from the water bottle out through a spout 365, said spout 365 being connected to the first water delivery tube 360 to provide a channel for water to be expelled from the fluid dispenser 310, while the first water delivery tube 360 is engaged with the receiving means 335 to direct water out of the water bottle.

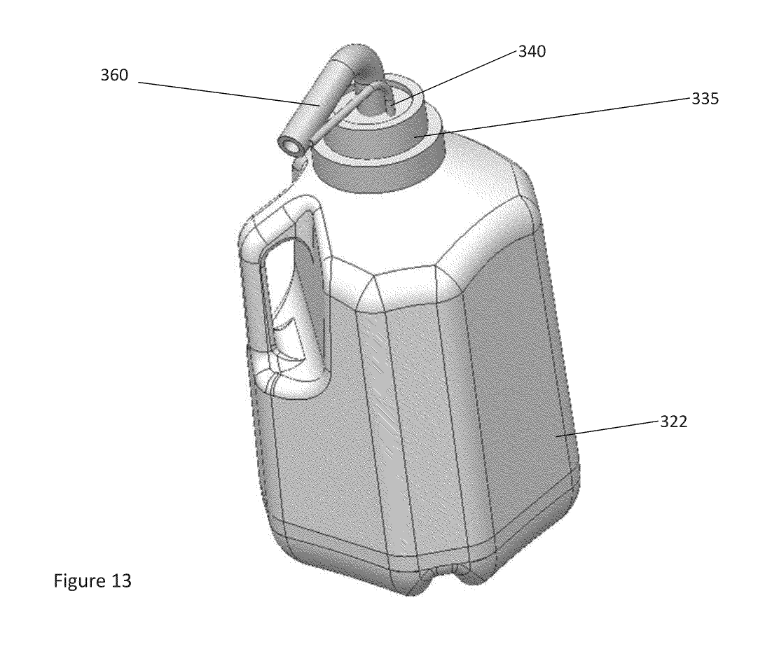

With reference to FIG. 13 and according to a fourth embodiment of the present invention, the receiving means 335 is fastened onto the water bottle 322, having the first water delivery tube 360 and first check valve tube 340 secured within the receiving means 335 and into the water bottle 322 for dispensing water and allow air to flow into said water bottle 322 as it empties itself through continued use.

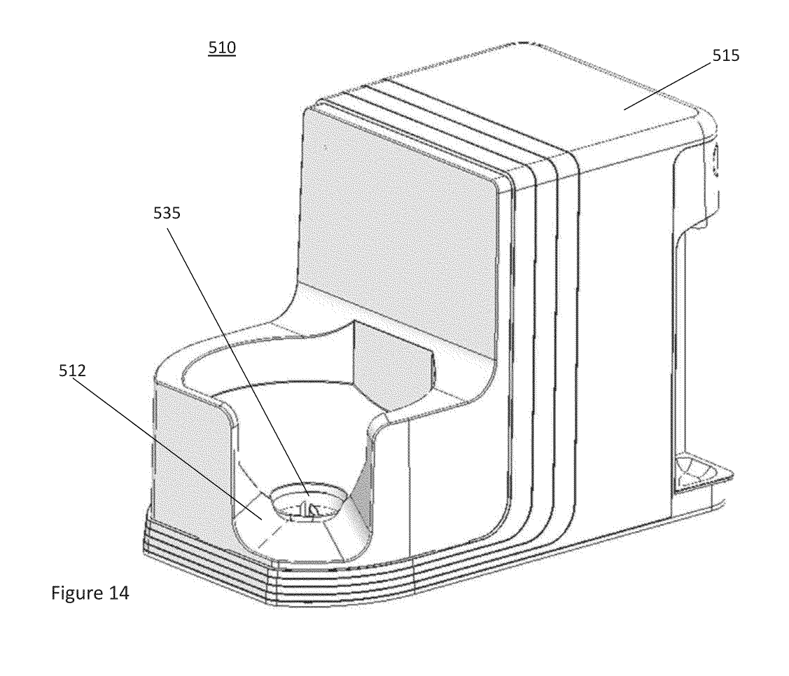

With reference to FIG. 14 and according to a fifth embodiment of the present invention, the fluid dispenser 510 is shown, with the housing 515 having a depression 512 in order to properly allow for a bottle (not shown) having a handle to be placed securely onto the receiving means 535.

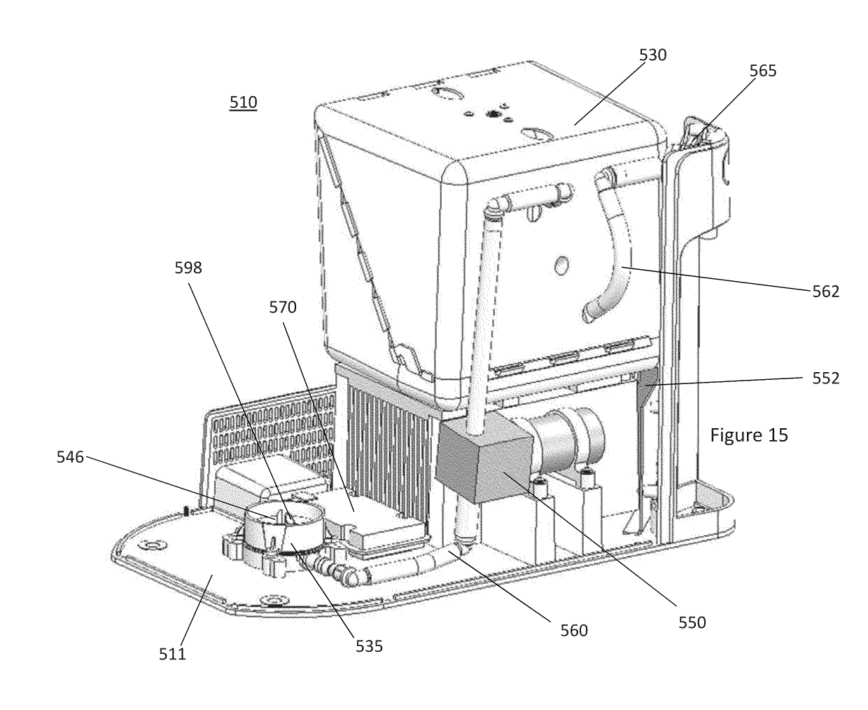

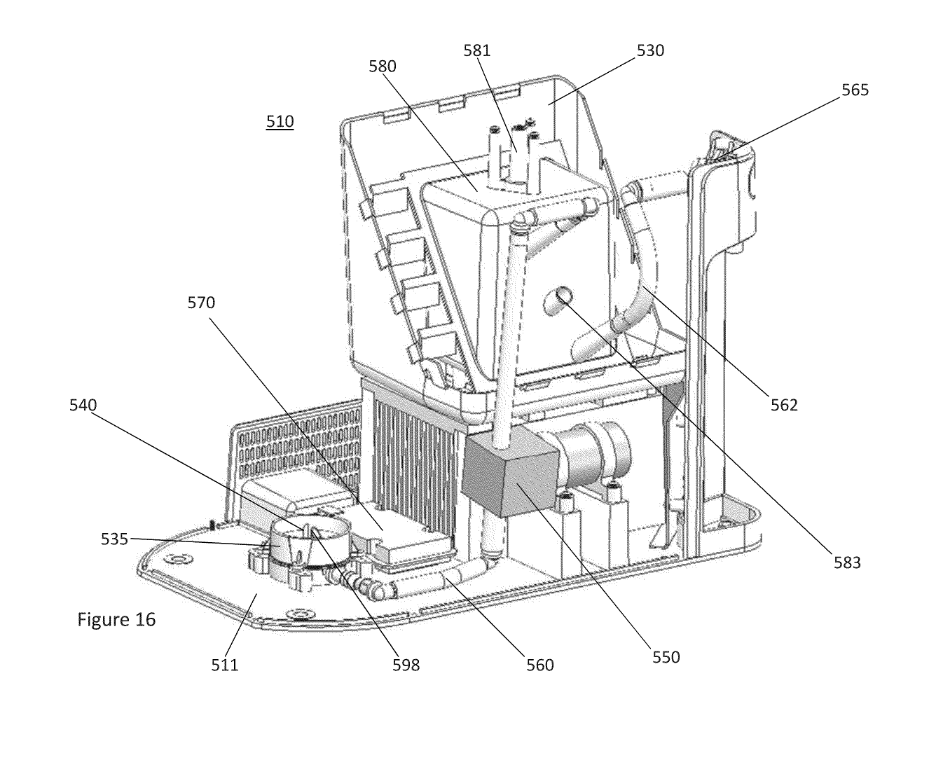

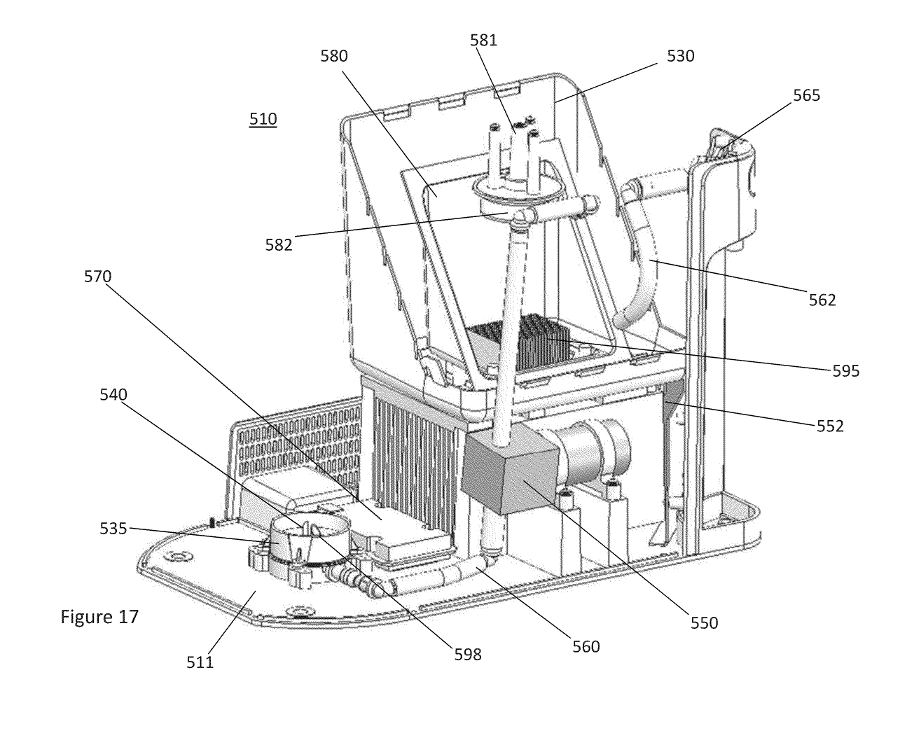

With reference to FIGS. 15, 16 and 17, the fluid dispenser 510 is shown without a housing (not shown) for substantially encasing the fluid dispenser 510, a receiving means 535 connected to the housing (not shown) for receiving and positioning a water bottle within the fluid dispenser 510, a pump 550 connected to the receiving means 535 to transfer water out of the water bottle, a water tank 580 and heat sink 595 connected to the pump 550 for storing and cooling the water, a spout 565 connected to the water tank 580 to dispense water from the fluid dispenser 510. The receiving means 535 is positioned on a base 511 of the fluid dispenser 510 and located adjacent to the water tank 580 and therefore allows the bottle to sit on the same horizontal plane as the water tank 580, which reduces the space taken in one's kitchen for the fluid dispenser 510. In operation, the bottle is placed upside down into the receiving means 535, where said bottle is pierced by a piercing member 598 as described above. As the spout 565 is electrically connected to the pump 550, once said spout 565 is pressed, the pump 550 is activated and pumps water from the water bottle into the water tank 580 through a first water delivery tube 560. A worker skilled in the relevant art would appreciate that the first water delivery tube 560 could be absent such that the pump 550 would be connected directly to the receiving means 535 without departing from the scope of the invention. If the water tank 580 is empty, water begins to fill the water tank 580 and will not yet be expelled from the spout 565 as the air will escape from a passage 581 located at the top of the water tank 580, said passage 581 at a lower height than that of the spout 565. A float valve 582 is positioned on the inside upper portion of the water tank 580, and serves to block the escape of air through the passage 581 as the water level within the water tank 580 increases. Indeed, as the spout 565 is still activated and thus the pump 550 pumps water into the water tank 580, the water eventually reaches the level of the float valve 582. At that point, a float (not shown) within the float valve is pushed upwardly, blocking the escape of air through the passage 581. At this point, water will be forced to be expelled out of the spout 565 as the only means of escape. During non-use, water within the water tank 580 is stagnant and therefore the heat sink 595 located on lower inside portion of the water tank 580 will cool the water, with the water located at the lower end of the water tank 580 being the coldest. Water will flow from a lower end of the water tank 580 through a second water delivery tube 562 in order to deliver the coldest water to the spout 565. Once the bottle is empty, a new bottle is placed onto the receiving means 535 and the process resumes. A fan 554 is positioned on the fluid dispenser 510 in order to expel any heat generated from the heat sink. An electronic circuitry box 570 is also positioned on the base 511 of the fluid dispenser 510 and in front of the main heat sink to improve electronics cooling and to house the circuitry required for the pump, or for other equipment such as a thermocouple, etc. Said thermocouple (not shown) would be attached to a protrusion 583 of the water tank 580. While the spout 565 is not described in great detail, a worker skilled in the art would appreciate that pressing the spout 565 will firstly mechanically activate a check valve located within the spout 565 to allow water to be expelled from the spout, and secondly electrically activate a switch which will in turn activate the pump 550 which will force water out of the bottle and through the spout 565. This sequence of activation clears the passage to allow for the water to be able to flow through the spout 565 first before the pump is activated second. The receiving means 535 of the fluid dispenser 510 is similar to the functioning in the other embodiments. Namely, the receiving means 535 is comprised of a piercing member 598 which can pierce the top of a bottle, and connected to a first water delivery tube 560 or a pump 550 directly to funnel the water into the water tank 580. A first check valve tube 540 is also present connected to a first check valve (not shown), which will also separately pierce the bottle and allow air to enter said bottle without spilling any water and therefore for water to exit the bottle through the piercing member 598.

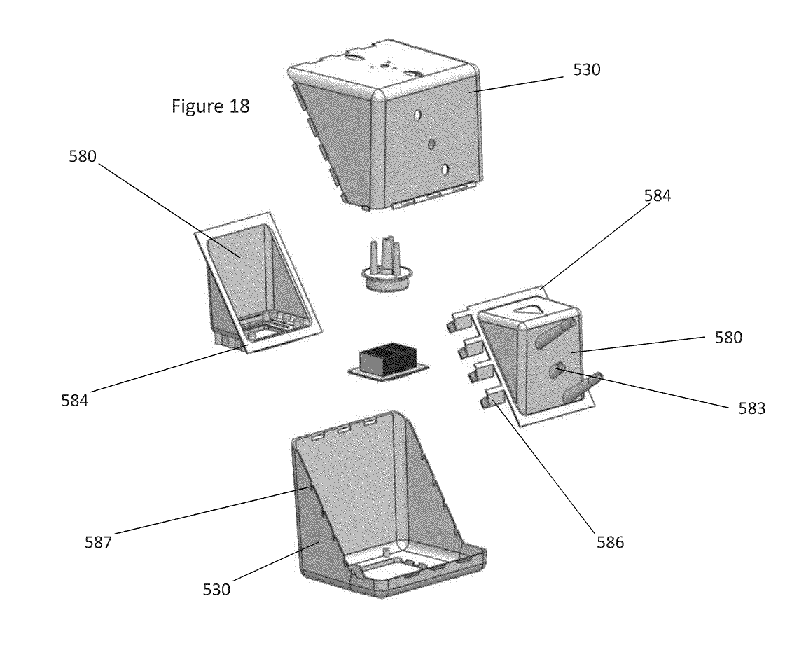

With reference to FIG. 18 and according to another embodiment of the present invention, the water tank 580 and water tank housing 530 are shown as an Exploded view. The area defined in between the water tank 580 and the water tank housing 530 allows for an insulation foam (not shown) to be inserted therein and keep the water tank 580 as cold as possible. The water tank 580 is comprised of flanges 584 which are glued one to the other for enclosing the water tank 580. The water tank 580 is further comprised of fins 586 for securing into grooves 587 of the water tank housing 530. These fins and 586 and grooves 587 also prevents the insulation foam (not shown) to cause any unwanted wall deflection when said foam (not shown) expands. Further, both the water tank 580 and the water tank housing 530 are shaped so as to only create a two-part mold thus making the molding process easier and cheaper.

Although the device has been described above by reference to certain embodiments of the device, the device is not limited to the embodiments described above. Modifications and variations of the embodiments described above will occur to those skilled in the art in light of the above teachings. Moreover, with respect to the above description, it is to be repulsed that the optimum dimensional relationships for the component members of the present device may include variations in size, material, shape, form, funding and manner of operation.

1. A fluid dispenser comprising:
a. a housing having a base for substantially encasing the fluid dispenser;
b. a receiving means connected to the housing for receiving and positioning a water bottle within the fluid dispenser;
c. a pump connected to the receiving means to transfer water out of the water bottle;
d. a water tank and heat sink connected to the pump for storing and cooling the water;
e. a spout connected to the water tank to dispense water from the fluid dispenser;
wherein the receiving means is positioned on the base of the fluid dispenser.

2. The fluid dispenser of claim 1 further comprised of a water tank housing.

3. The fluid dispenser of claim 2 further comprised of insulating foam located in a space between the water tank and the water tank housing.

4. The fluid dispenser of claim 1 further comprised of a first water delivery tube connected from the receiving means to the pump.

5. The fluid dispenser of claim 1 further comprised of a second water delivery tube connected from the water tank to the spout.

6. The receiving means of claim 1 further comprised of piercing means to pierce the water bottle.

7. The receiving means of claim 1 further comprised of a first check valve tube connected to a first check valve to allow air to enter the water bottle.

8. The water tank of claim 1 further comprised of gluing flanges to seal one half of the water tank into the other half.

9. The water tank of claim 2 further comprised of fins to be secured into grooves of the water tank housing.

10. The fluid dispenser of claim 1 further comprised of a float valve secured into the water tank.

11. The water tank of claim 1 further comprised of an escape passage.

12. The fluid dispenser of claim 1 further comprised of a thermocouple to secure to a protrusion of the water tank.

13. The water tank of claim 1 further comprised of a heat sink located on the inner bottom of said water tank to cool the water.

14. The spout of claim 1 further comprised of a check valve and a switch, wherein the check valve is mechanically activated first to create an opening and allow for the flow of water and the switch is electrically activated second to activate the pump.

15. The fluid dispenser of claim 1 further comprised of a fan.
